(19) United States
(12) Patent Application Publication
(10) Pub. No.: US 2026/0085786 A1
(43) Pub. Date: Mar. 26, 2026

(54) CONTAINER FOR COLLECTING AND CONTAINING A LIQUID DRAINED FROM A VEHICLE

(71) Applicant: CANADIAN TIRE CORPORATION, LIMITED, Toronto (CA)

(72) Inventors: David GREEN, Toronto (CA); Aras PUODZIUNAS, Toronto (CA); Abdul Haleem Ahamed KOYA, Oakville (CA); John SCHMIDER, Scarborough (CA)

(21) Appl. No.: 18/963,654

(22) Filed: Nov. 28, 2024

Related U.S. Application Data
(60) Provisional application No. 63/698,115, filed on Sep. 24, 2024.

(51) Int. Cl. F16N 31/00; B65D 1/18; B65D 1/20; B65D 1/40; B65D 41/02; B65D 47/32

(52) U.S. Cl. CPC F16N 31/004; B65D 1/18; B65D 1/20; B65D 1/40; B65D 41/02; B65D 47/32

(57) ABSTRACT

A container for collecting a liquid drained from a vehicle comprises a pan for collecting the liquid being drained from the vehicle and a vessel for containing the liquid collected with the pan. The vessel includes a vented inlet and an inlet cap to occlude the vented inlet. The vessel includes a vented outlet and an outlet cap to occlude the vented outlet. The vessel is devoid of an additional vent that the user must remember to open/close and that is prone to leaking.

### CROSS REFERENCE TO RELATED APPLICATION AND CLAIM OF PRIORITY

The present application claims priority to U.S. provisional patent application No. 63/698,115 filed on Sep. 24, 2024, the entire contents of which are hereby incorporated herein by reference.

### TECHNICAL FIELD

The disclosure relates generally to liquid containers, and more particularly to containers for collecting and containing a liquid drained from a vehicle.

### BACKGROUND

It is common to use an oil drain pan to collect engine oil when servicing a vehicle. Some oil drain pans are open and can resemble a wide shallow bowl while other oil drain pans are integrated in a portable container defining a closed vessel to contain the oil and facilitate the transport of the oil to a suitable recycling facility. Existing open oil drain pans and oil drain pans that are integrated in portable containers can be prone to spillage during collection and/or during transport of the oil. Improvement is desirable.

### SUMMARY

In one aspect, the disclosure describes a container for collecting and containing a liquid drained from a vehicle. The container comprises:
a pan for collecting the liquid drained from the vehicle;
a vessel for containing the liquid collected with the pan, the vessel including:
a vented inlet operable to permit the liquid collected by the pan to be received into the vessel, the vented inlet including an inlet liquid passage and an inlet vent; and
a vented outlet operable to permit the liquid contained in the vessel to be poured out of the vessel, the vented outlet including an outlet liquid passage and an outlet vent;
an inlet cap operable to selectively occlude the vented inlet to prevent liquid flow out of the vessel via the vented inlet; and
an outlet cap operable to selectively occlude the vented outlet to prevent liquid flow out of the vessel via the vented outlet.

The vessel may be devoid of a manually actuatable vent outside of the vented outlet and outside of the vented inlet.

The vessel may be devoid of an additional vent outside of the vented outlet and outside of the vented inlet.

The container may be devoid of an additional cap other than the inlet cap and the outlet cap.

When the container is in a liquid-collecting orientation: the pan may include a pan surface downwardly sloped toward the vented inlet; the inlet liquid passage may include an inlet liquid opening defined in a wall of the vessel; and the inlet vent may include an inlet vent opening that is above the inlet liquid opening.

The inlet liquid opening may be below a portion of the pan surface adjacent the vented inlet.

The vent opening may be above the portion of the pan surface adjacent the vented inlet.

The vent opening may be above a portion of the pan surface adjacent the vented inlet.

The vent opening may be located centrally of the vented inlet.

The inlet liquid opening may be one of a plurality of inlet liquid openings of the vented inlet. The vent opening may be located centrally of the plurality of inlet liquid openings.

The vent opening may be disposed atop a protrusion extending upwardly from the wall.

The protrusion may have a frustoconical shape.

The protrusion may be integrally formed with the wall of the container in which the inlet liquid opening is defined.

The protrusion may extend above at least part of the pan surface. The inlet cap may be shaped to accommodate the protrusion therein.

The outlet liquid passage may extend along an outlet axis. The container may have an upright axis that is: horizontal when the container is disposed on a horizontal surface in a liquid-collecting orientation; and vertical when the container is disposed on the horizontal surface in an upright orientation. The vented outlet may be in an upper portion of the container when the container is in the upright orientation. The outlet axis may be between 25° and 65° from the upright axis.

The upright axis and the outlet axis may be coplanar.

The outlet vent may be defined by a straw that extends into the vessel. The straw may be longer than the liquid outlet passage.

In some embodiments, an entirety of the straw may be parallel to the outlet axis.

The container may include a bottom pad for engaging a support surface when the container is in a liquid-collecting orientation. The bottom pad may be sized to fit in a mouth of a pan of another identical container and permit the bottom pad to be received in the mouth of the other container when the container and the other container are stacked.

Embodiments may include combinations of the above features.

In another aspect, the disclosure describes a container for collecting and containing a liquid drained from a vehicle. The container comprises:
a pan for collecting the liquid drained from the vehicle when the container is in a liquid-collecting orientation; and
a vessel for containing the liquid collected with the pan, the vessel including:
a vented inlet operable to permit the liquid collected by the pan to be received into the vessel, the vented inlet including:
a trough defining a liquid opening into the vessel; and
a protrusion surrounded by the trough and defining a vent opening for venting the vessel, the protrusion extending upwardly relative to the trough so that the vent opening is disposed higher than the liquid opening when the container is in the liquid-collecting orientation, the protrusion being integrally formed with the trough; and
an outlet operable to permit the liquid contained in the vessel to be removed from the vessel.

The trough and the protrusion may be integrally formed with a main body of the container.

The protrusion may have a frustoconical shape.

The vent opening may be disposed atop the protrusion.

The liquid opening may be one of a plurality of liquid openings defined in the trough. The vent opening may be located centrally of the plurality of liquid openings.

The pan may include a pan surface downwardly sloped toward the vented inlet when the container is in the liquid-collecting orientation. The protrusion may extend above at least part of the pan surface.

The trough may have an annular shape. The protrusion may be disposed centrally of the trough.

Embodiments may include combinations of the above features.

In a further aspect, the disclosure describes a method for blow-molding an integrally-formed main body of a container for collecting and containing a liquid drained from a vehicle, the main body defining: a pan for collecting the liquid drained from the vehicle and a vessel for containing the liquid collected with the pan. The method comprises:
inserting a polymeric workpiece into a mold defining a shape of the main body, the mold including:
a first mold surface for molding the pan;
a second mold surface for molding a trough of a vented inlet of the vessel; and
a third mold surface defining a cavity extending from the second mold surface for molding a protrusion of the vented inlet surrounded by the trough and protruding outwardly relative to the vessel;
injecting a pressurized fluid into the workpiece to inflate the workpiece into the mold and form the main body; and
releasing the main body from the mold.

The method may comprise forming a liquid passage through the wall of the vented inlet.

The liquid passage may be formed after releasing the main body of the container from the mold.

The method may comprise forming a vent through the protrusion of the vented inlet.

The vent may be formed atop the protrusion of the vented inlet.

The cavity may have a frustoconical shape.

The second mold surface for molding the wall of the vented inlet may be offset from the first mold surface for molding the pan.

Embodiments may include combinations of the above features.

In a further aspect, the disclosure describes a container for collecting and containing a liquid drained from a vehicle. The container comprises:
a pan for collecting the liquid drained from the vehicle when the container is in a liquid-collecting orientation;
a vessel for containing the liquid collected with the pan, the vessel including:
a vented inlet operable to permit the liquid collected by the pan to be received into the vessel, the vented inlet including:
a perforated trough defining a liquid opening into the vessel; and
a protrusion surrounded by the trough and defining a vent opening for venting the vessel, the protrusion extending upwardly relative to the trough so that the vent opening is disposed higher than at least part of the pan when the container is in the liquid-collecting orientation; and
an inlet cap operable to selectively occlude the vented inlet to prevent liquid flow out of the vessel via the vented inlet, the inlet cap being shaped to accommodate the protrusion therein.

The vessel may include a vented outlet operable to permit the liquid contained in the vessel to be removed from the vessel. The container includes an outlet cap operable to selectively occlude the vented outlet to prevent liquid flow out of the vessel via the vented outlet.

The vessel may be devoid of an additional vent outside of the inlet vent and the outlet vent.

The trough may be part of a recess extending from the pan and integrally formed with the pan. The inlet cap may be engageable with the recess via a screw thread.

The protrusion may be disposed centrally of the recess.

The protrusion may have a frustoconical shape. The vent opening may be disposed atop the protrusion.

The vent opening may be above a portion of a downwardly sloped surface of the pan adjacent the vented inlet when the container is in the liquid-collecting orientation.

Embodiments may include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1 is a perspective view of an exemplary container for collecting and containing a liquid drained from a vehicle, the container being shown in a liquid-collecting orientation;

FIG. 2 is front elevation view of the container in an upright orientation;

FIG. 3 is a cross-sectional view of the container taken along line 3-3 in FIG. 1 with an inlet cap removed;

FIG. 4 is an enlarged top view of a vented inlet of the container;

FIG. 5 is an enlarged view of region 5 in FIG. 3 showing a cross-sectional view of the vented inlet without the inlet cap along line 3-3 in FIG. 1;

FIG. 6 is an enlarged cross-sectional view of the vented inlet and the inlet cap taken along line 3-3 in FIG. 1;

FIG. 7 is an enlarged cross-sectional view of a vented outlet and an outlet cap of the container taken along line 7-7 in FIG. 1;

FIG. 8 is an enlarged perspective view of the vented outlet with the outlet cap removed;

FIG. 9 is a cross-sectional view of the container in the upright orientation taken in a vertical plane that is normal to the viewing direction of FIG. 9;

FIGS. 10A-10F are cross-sectional views of the container in the upright orientation taken in a vertical plane that is normal to the viewing direction of FIG. 10, and respectively show a plurality of instances of the container at different tilt orientations to show the liquid contained therein;

FIG. 11 is a flow diagram of a method for blow-molding an integrally-formed main body of a container for collecting and containing a liquid drained from a vehicle;

FIGS. 12A-12C schematically illustrate steps of a blow molding operation used in the method of FIG. 11;

FIG. 13 is a schematic cross-sectional view of a portion of a mold for blow molding part of the main body;

FIG. 14 is a schematic cross-sectional view of a portion of the main body in conjunction with a tool for forming fluid passages through walls of the main body;

FIG. 15 is a perspective view of a stack of two containers; and

FIG. 16 is an enlarged cross-sectional view through the stack of containers taken along line 16-16 in FIG. 15.

### DETAILED DESCRIPTION

This disclosure describes containers for collecting and containing used (e.g., automotive) liquids drained from vehicles, methods of manufacturing such containers and also methods of using such containers. The containers may be used to collect one or more liquids such as engine oil, gear oil, liquid coolant, transmission fluid, brake fluid, power steering fluid and/or windshield washing fluid when servicing a vehicle such as an automobile, a truck or a motorcycle for example. The containers may also be used to contain and optionally transport the collected liquid(s) to a suitable (e.g., recycling) facility.

A container may include a pan for collecting the liquid drained from the vehicle and a closeable vessel for containing the liquid collected with the pan. In some embodiments, the containers disclosed herein may reduce the likelihood of spillage during the collection and/or transport of the liquids. For example, a container may include a vented inlet and a vented outlet, and may be devoid of an additional/separate vent that the user may forget to open/close during use and that may be prone to leaking. In some embodiments, the vented inlet may reduce the likelihood of sputtering or gurgling during liquid collection, and thereby reduce the likelihood of the vented inlet becoming flooded as air from within the vessel tries to exit the vessel at the same time as the liquid is entering the vessel. In some embodiments, the vented inlet may be integrally formed with a main body of the container to facilitate manufacturing of the container. In some embodiments, the vented outlet may facilitate pouring of the collected liquid out of the vessel. Aspects of various embodiments are described through reference to the drawings.

The term “substantially” as used herein may be applied to modify any quantitative representation which could permissibly vary without resulting in a change in the basic function to which it is related.

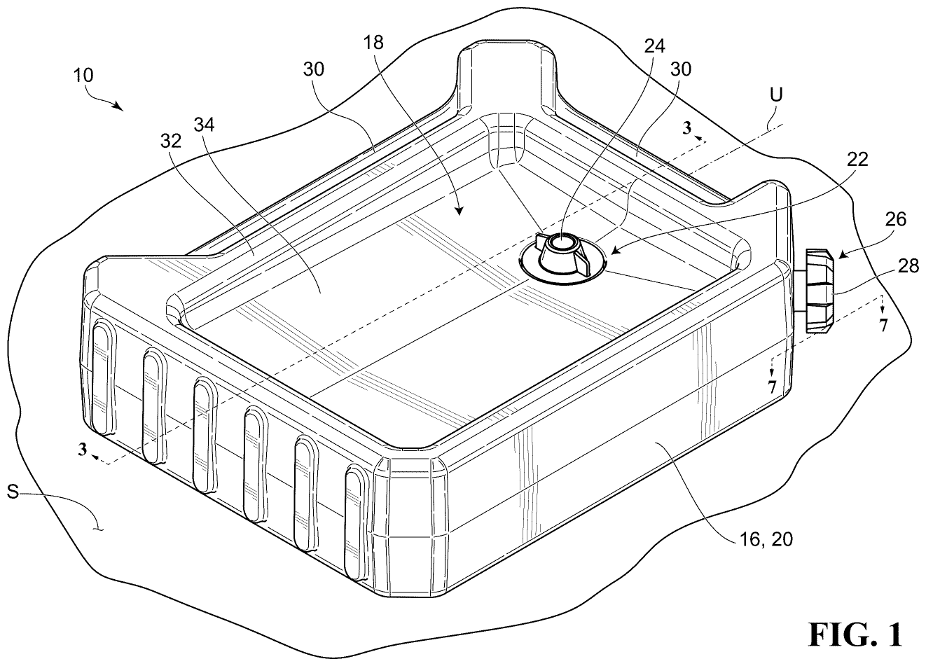

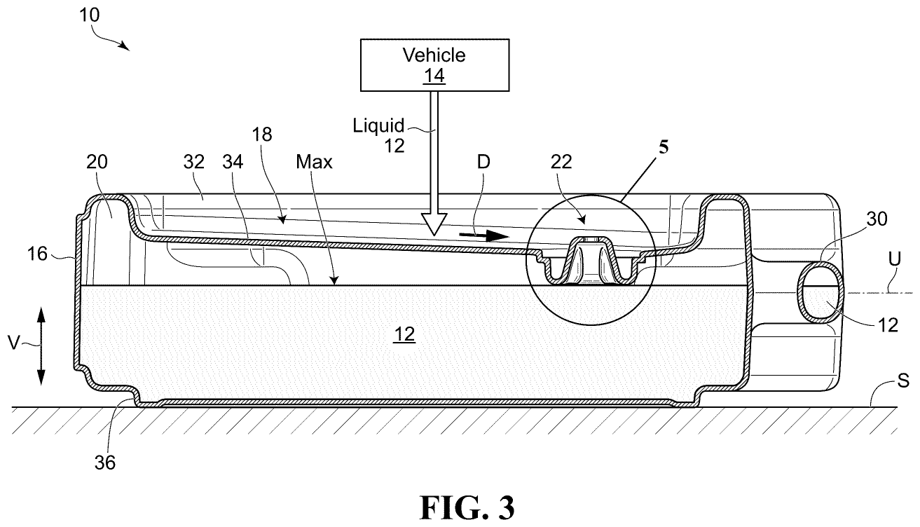

FIG. 1 is a perspective view of an exemplary container 10 for collecting and containing (e.g., automotive) liquid 12 (shown in FIG. 3) drained from vehicle 14 (shown in FIG. 3). Container 10 may include main body 16 defining pan 18 (i.e., catch basin) for collecting liquid 12 being drained from vehicle 14, and closeable vessel 20 for containing liquid 12 collected with pan 18. FIG. 1 shows container 10 in a liquid-collecting orientation where container 10 is laid flat on (e.g., horizontal) surface S (e.g., ground, driveway, garage floor) with pan 18 facing upward.

Vessel 20 may include vented inlet 22 operable to permit liquid 12 collected by pan 18 to flow into vessel 20. Container 10 may include inlet cap 24 operable to selectively open vented inlet 22 during the collection of liquid 12 to permit liquid 12 to be received into vessel 20, and selectively occlude vented inlet 22 after the collection of liquid 12 to prevent liquid 12 from flowing out of vessel 20 via vented inlet 22 during storage and/or transport of liquid 12 for example. Vessel 20 may include vented outlet 26 operable to permit liquid 12 contained in vessel 20 to be removed from (e.g., poured out of) vessel 20. Container 10 may include outlet cap 28 operable to selectively open vented outlet 26 for pouring liquid 12 out of vessel 20, and to selectively occlude vented outlet 26 to prevent liquid 12 from flowing out of vessel 20 via vented outlet 26 during collection, storage and/or transport of liquid 12 for example. Inlet cap 24 and/or outlet cap 28 may optionally be attached to main body 16 via a lanyard to prevent inlet cap 24 and/or outlet cap 28 from getting lost.

Other than venting of vessel 20 via vented inlet 22 and vented outlet 26, container 10 may be devoid (i.e., free of) of any additional (e.g., manually actuatable) vent(s) outside of vented inlet 22 and vented outlet 26. This may eliminate the need for the user to remember to manually actuate (e.g., close/open) any additional vent(s). Consequently, this may eliminate the risk of the user forgetting to close/open such additional vent(s) and thereby reduce the risk of leakage via such additional vent(s). Accordingly, container 10 may be devoid of any additional removable (e.g., threaded) cap(s) or (e.g., press-fitted) plugs associated with such additional vents. Container 10 may be devoid of any additional removable (e.g., threaded) cap(s) or (e.g., press-fitted) plugs other than inlet cap 24 and outlet cap 28.

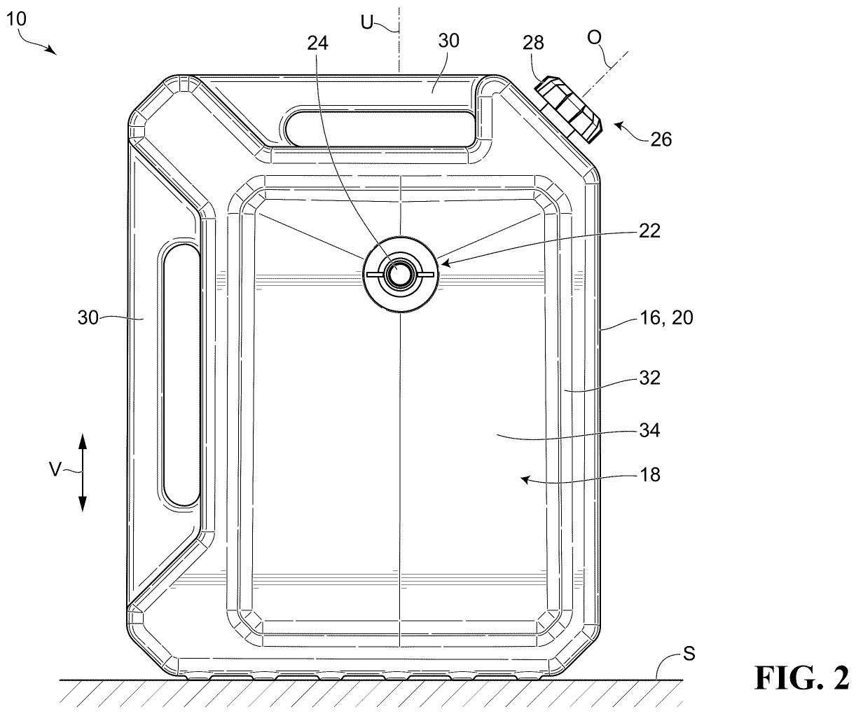

FIG. 2 is front elevation view of container 10 resting on (e.g., horizontal) surface S in an upright orientation. The upright orientation of container 10 may be used during storage and/or transport of liquid 12. Container 10 may be multi-sided and may be placed on surface S in other orientations. For reference herein, an upright axis U of container 10 may be defined as being parallel to vertical direction V when container 10 is disposed on a horizontal surface S in the upright orientation. In other words, upright axis U may be perpendicular to surface S. In some embodiments, container 10 and pan 18 may each have an elongated shape and upright axis U may be a longitudinal axis of container 10 and/or of pan 18. The elongated shape of pan 18 may facilitate collection of liquid 12 from an initial strong stream of liquid 12 down to a trickle, which may have different trajectories depending on the orientation of the drain plug on vehicle 14. Upright axis U may be horizontal when container 10 is disposed on horizontal surface S in a liquid-collecting orientation as shown in FIG. 1.

Container 10 may include one or more handles 30 to facilitate the manipulation and carrying of container 10. In some embodiments, one handle 30 may be disposed on each of two sides of pan 18 to facilitate the sliding of container 10 along surface S under vehicle 14 to position (e.g., adjust, align) pan 18 with a drain plug of vehicle 14 and/or with a stream of liquid 12 being drained from vehicle 14 for example. Having handle(s) 30 on different sides of container 10 may also facilitate the carrying and storage of container 10 in different orientations. Handles 30 may be part of (i.e., integrally formed with) main body 16. Handles 30 may be hollow and be part of vessel 20 so that liquid 12 may be received inside of handles 30 as well.

FIG. 3 is a cross-sectional view of container 10 taken along line 3-3 in FIG. 1 with inlet cap 24 removed from vented inlet 22 to permit liquid 12 collected into pan 18 to be received into vessel 20 via vented inlet 22. Outlet cap 28 may be installed to occlude vented outlet 26 during liquid collection. FIG. 3 shows container 10 disposed under vehicle 14 that is being serviced. Container 10 is shown as being in the liquid-collecting orientation where liquid 12 is being drained from vehicle 14 and collected into pan 18. Pan 18 may be defined as a recess formed on one side of main body 16. Pan 18 may include mouth 32 defining an opening of pan 18 via which liquid 12 is received during the collection of liquid 12. Mouth 32 of pan 18 may have an elongated (e.g., generally oval or rectangular) shape as shown in FIGS. 1 and 2. Pan 18 may include bottom pan surface 34 that may be downwardly sloped toward vented inlet 22 so that liquid 12 that is received in pan 18 may flow (i.e., drain) toward vented inlet 22 along arrow D when container 10 is in the liquid-collecting orientation. When collection of liquid 12 from vehicle 14 has been completed, residual liquid 12 on pan surface 34 may be removed/wiped/cleaned and inlet cap 24 may be installed on vented inlet 22 so that the filled container 10 may be transported. Pan surface 34 may be relatively smooth (e.g., free of protrusions such as ribs and free of recesses such as grooves) to facilitate cleaning.

FIG. 3 shows vessel 20 being filled to its maximum capacity indicated by MAX level represented by a horizontal line that extends across the top of liquid 12. The MAX level may be selected to be immediately below vented inlet 22. Container 10 may be sized to accommodate one or more service events of vehicle 14. For example, container 10 may be sized to accommodate one or more engine oil changes for vehicle 14. In various embodiments, container 10 may have a maximum capacity between 5 litres and 20 litres. In some embodiments, container 10 may have a maximum capacity between 10 litres and 20 litres. In some embodiments, container 10 may have a maximum capacity of about 15 litres.

Container 10 may include bottom pad 36 for engaging with surface S when container 10 is in the liquid-collecting orientation. Bottom pad 36 may protrude outwardly from a remainder of main body 16 and may be sized to facilitate stacking of containers 10 as explained below.

FIG. 4 is an enlarged top view of vented inlet 22 of container 10 with inlet cap 24 removed from vented inlet 22 representing a situation where liquid 12 may be collected and received inside of vessel 20. Vented inlet 22 may be partially defined inside of recess 38 extending downwardly from pan surface 34 and being integrally formed with pan surface 34. In some embodiments, all of the elements of vented inlet 22 may be integrally formed with main body 16 of container 10. The term “integrally formed” as used herein is intended to mean that the elements have a unitary (i.e., one-piece) construction. For example, integrally formed elements may be molded together in a same molding operation from a same material and have a monolithic construction. Alternatively, in some embodiments, some elements of vented inlet 22 may be separately manufactured as individual components that may be subsequently assembled (e.g., fastened, press-fitted, threaded, bonded, glued) with main body 16.

Vented inlet 22 may include one or more inlet liquid openings 40 formed in wall 42 of container 10. Recess 38 may have a generally cylindrical shape and have a circular profile. In some embodiments, recess 38 may have an oval, rectangular or other profile. Wall 42 may define a bottom of recess 38. Wall 42 may define a flat or rounded bottom of recess 38. Wall 42 may be part of a perforated trough 45 defined in recess 38. Trough 45 may follow the profile of recess 38. For example, trough 45 may be annular. Recess 38 may be partially defined by peripheral wall 43. In other words, wall 42 may be recessed relative to pan 18. In some embodiments, peripheral wall 43 may be vertically tapered by a suitable draft angle to facilitate a molding operation. Wall 42, and trough 45 defined by wall 42, may be integrally formed with pan 18 and with main body 16. Inlet liquid openings 40 may be part of respective inlet liquid passages that permit the flow of liquid 12 that is collected with pan 18 through wall 42 and into vessel 20. Wall 42 and inlet liquid openings 40 may be below a portion of pan surface 34 that is adjacent vented inlet 22 so that liquid 12 may be received in trough 45 defined in recess 38 and then flow through inlet liquid openings 40 and into vessel 20.

Vented inlet 22 may include one or more inlet vent openings 44 (referred hereinafter in the singular) that are part of respective vents (e.g. air passages) providing venting of vessel 20 during the collection of liquid 12. In some embodiments, vented inlet 22 may include a plurality of inlet liquid openings 40 defined in wall 42 and inlet vent opening 44 may be located centrally of the plurality of inlet liquid openings 40. Inlet vent opening 44 may be located centrally of vented inlet 22. Inlet vent opening 44 may be located centrally of wall 42. Inlet vent opening 44 may be located centrally of recess 38.

Inlet vent opening 44 may be disposed above inlet liquid openings 40 when container 10 is in the liquid-collecting orientation. Inlet vent opening 44 may be disposed above the portion of the downwardly sloped pan surface 34 adjacent vented inlet 22. For example, inlet vent opening 44 may be disposed on or atop hollow protrusion 46 extending upwardly from wall 42. For example, trough 45 defined by recess 38 may partially or completely surround protrusion 46 in various embodiments. Protrusion 46 may extend upwardly relative to trough 45. Protrusion 46 may be integrally formed with wall 42, with pan 18 and with a remainder of main body 16. Protrusion 46 may extend vertically from wall 42. Wall 42 may have a substantially circular periphery and protrusion 46 may be disposed centrally of recess 38. For example, protrusion 46 may be disposed centrally of trough 45. In some embodiments, protrusion 46 may extend vertically beyond recess 38 and higher than at least part of pan surface 34. Accordingly, inlet vent opening 44 may be positioned to continue performing its venting function even if recess 38 happens to get completely filled with liquid 12 during collection of liquid 12.

In various embodiments, protrusion 46 may have a cylindrical or prismatic shape. Protrusion 46 may have an axially uniform cross-sectional shape or be vertically tapered by a suitable draft angle to facilitate a molding process. In some embodiments, protrusion 46 may have a frustoconical shape and resemble a volcano. In some embodiments, protrusion 46 may have a pyramidal shape. In some embodiments, protrusion 46 may have a tubular (e.g., straw) shape. In some embodiments, vented inlet 22 may include only one (i.e., sole) inlet vent opening 44, which may be disposed atop protrusion 46.

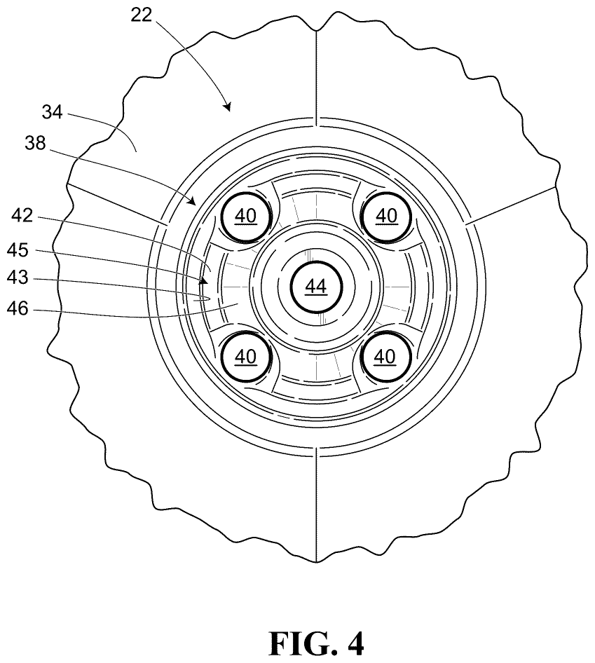

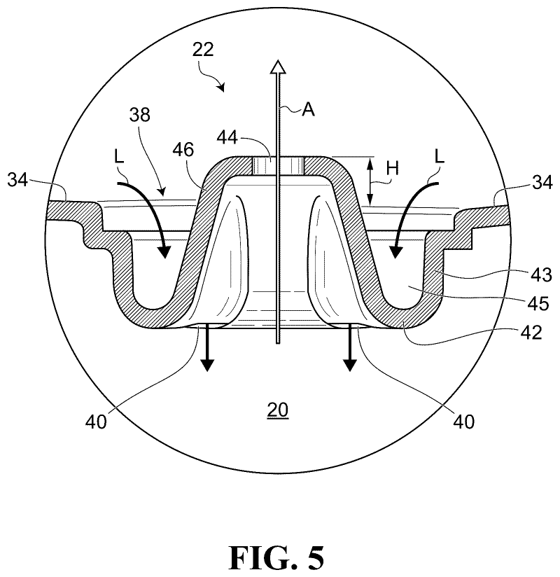

FIG. 5 is an enlarged view of region 5 in FIG. 3 showing a cross-sectional view of vented inlet without the inlet cap along line 3-3 in FIG. 1. In some embodiments, inlet liquid openings 40 may be partially formed (e.g., cut into) central protrusion 46. FIG. 5 illustrates the flow of liquid 12 and air through vented inlet 22 during liquid collection by way of arrows L and A respectively. When liquid 12 is received in pan 18, pan surface 34 guides liquid 12 toward vented inlet 22. Liquid 12 enters recess 38 and flows into vessel 20 via inlet liquid openings 40. As liquid 12 is entering vessel 20, air is released from vessel 20 via a passage extending vertically through protrusion 46 and leading to inlet vent opening 44 disposed atop protrusion 46.

In some embodiments, inlet vent opening 44 may be disposed below pan surface 34 but above inlet liquid openings 40. In some embodiments, inlet vent opening 44 may be flush with pan surface 34 or be disposed above pan surface 34 by non-zero height H. In some embodiments, height H may be between 0 mm and 50 mm. In some embodiments, height H may be between 5 mm and 15 mm, which may facilitate venting for some flow conditions.

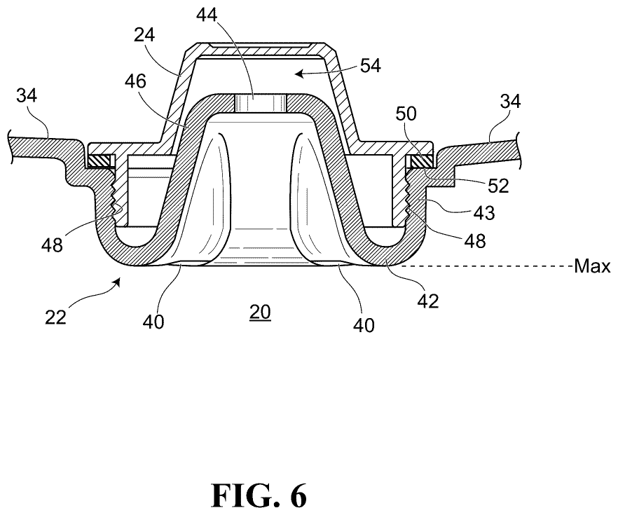

FIG. 6 is an enlarged cross-sectional view of vented inlet 22 and inlet cap 24 taken along line 3-3 in FIG. 1. Inlet cap 24 may be operable to selectively occlude vented inlet 22 to prevent flow of liquid 12 out of vessel 20 via vented inlet 22. Inlet cap 24 may be removed from vented inlet 22 during liquid collection and may be installed on vented inlet 22 after liquid collection and during storage and/or transport of the collected liquid 12 for example. In some embodiments, inlet cap 24 may be a plug that may be manually press-fitted inside recess 38 by a user of container 10. In some embodiments, inlet cap 24 may be selectively engageable with part of vented inlet 22. For example, inlet cap 24 may be manually threaded with protrusion 46 or with peripheral wall 43 of recess 38 via screw thread 48 (shown schematically in FIG. 6) to removably install inlet cap 24.

Inlet cap 24 may include optional seal 50 that may be retained thereon so that when inlet cap 24 is installed to occlude vented inlet 22, seal 50 may be operatively disposed between inlet cap 24 and part of main body 16 to prevent leakage of liquid 12 out of vessel 20 via vented inlet 22. For example, recess 38 may define annular seat 52 configured to interface with annular seal 50 and permit seal 50 to be compressed between a flange of inlet cap 24 and seat 52 when inlet cap 24 is installed. Seal 50 may be made from a compressible (i.e., resilient) material that has suitable resistance to the types of liquid 12 that may be collected by container 10. For example, seal 50 may be an annular gasket or O-ring that is made from a suitable elastomeric material (e.g., rubber).

In embodiments where protrusion 46 extends above at least part of pan surface 34, inlet cap 24 may be configured to accommodate part of protrusion 46 therein. For example, inlet cap 24 may include pocket 54 in which the top of protrusion 46 may be received when inlet cap 24 is installed. In some embodiments, inlet cap 24, may be manufactured by (e.g., injection) molding and be made from suitable polymeric material(s).

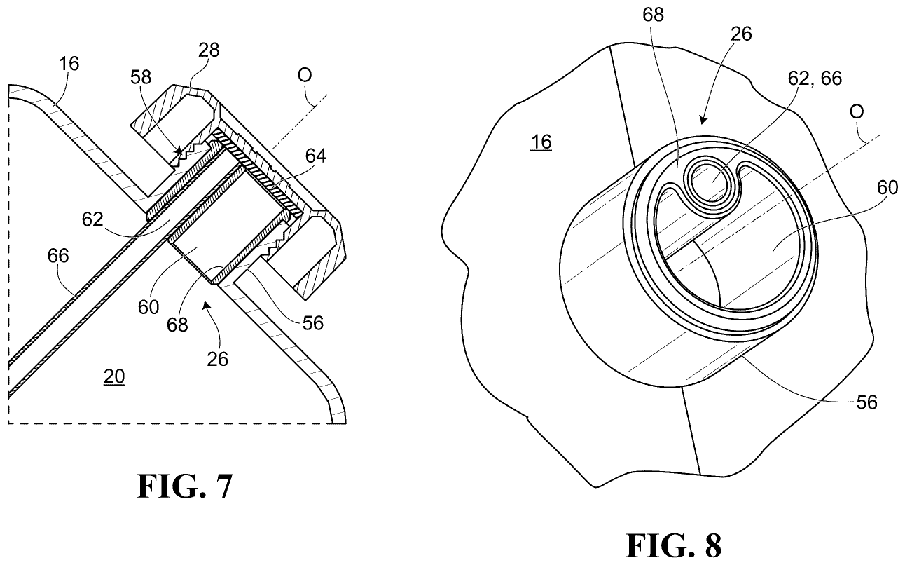

FIG. 7 is an enlarged cross-sectional view of vented outlet 26 with outlet cap 28 installed thereon taken along line 7-7 in FIG. 1. Outlet cap 28 may be operable to selectively occlude vented outlet 26 and selectively installed to prevent flow of liquid 12 out of vessel 20 via vented outlet 26. Outlet cap 28 may be installed during liquid collection and may be removed from vented outlet 26 to remove (e.g., pour) liquid 12 out of vessel 20 after transporting liquid 12 to the recycling facility. Alternatively, liquid 12 collected using container 10 may be poured into another (e.g., smaller) container such as an empty container of new oil and that other container may be taken to the recycling facility instead of container 10.

In some embodiments, outlet cap 28 may be a plug that may be manually press-fitted with collar 56 by a user of container 10. In some embodiments, outlet cap 28 may be manually threaded with collar 56 via screw thread 58 (shown schematically in FIG. 7) to removably install outlet cap 28. Collar 56 may be part of main body 16 and may be integrally formed therewith. Vented outlet 26 may include outlet liquid passage 60 and outlet vent 62. Outlet liquid passage 60 and outlet vent 62 may extend through collar 56.

Outlet cap 28 may include optional seal 64 that may be retained therein so that when outlet cap 28 is installed to occlude vented outlet 26, seal 64 may be operatively disposed between outlet cap 26 and part of main body 16 to prevent leakage of liquid 12 out of vessel 20 via vented outlet 26. Seal 64 may be sized and configured to interface with respective openings of outlet liquid passage 60 and outlet vent 62. In some embodiments, seal 64 may be disk-shaped gasket made from a compressible (i.e., resilient) material that has suitable resistance to the types of liquid 12 that may be collected by container 10. For example, seal 64 may be made from a suitable elastomeric material (e.g., rubber). When outlet cap 28 is installed, seal 64 may be pressed against the openings of outlet liquid passage 60 and outlet vent 62 so as to prevent liquid 12 from flowing out of vented outlet 26.

Vented outlet 26 may be disposed in an upper portion of container 10 when container 10 is in the upright orientation as shown in FIG. 2. Outlet liquid passage 60 may extend along outlet axis O.

Outlet vent 62 may be defined by straw 66 (i.e., tube) that is retained inside collar 56 and that extends into vessel 20 to provide venting during pouring of liquid 12 out of vessel 20. Straw 66 may be longer than a length of outlet liquid passage 60. Some or an entirety of straw 66 may be substantially parallel to outlet liquid passage 60 in some embodiments. Straw 66 may be substantially entirely straight, or some part(s) of straw 66 may be curved. Straw 66 may be made from a relatively rigid material so that straw 66 may not substantially deform due to its own weight or due to its interaction with liquid 12 inside of vessel 20.

FIG. 8 is an enlarged perspective view of vented outlet 26 with outlet cap 28 removed from vented outlet 26. Screw threads 58 may be formed on collar 56 and are not shown in FIG. 8. Vented outlet 26 may be operable to permit liquid 12 contained in vessel 20 to be poured out of vessel 20 when outlet cap 28 is removed. Vented outlet 26 may include insert 68 that may be installed (e.g., press-fitted, threaded, glued, bonded) into the interior of collar 56. Alternatively, insert 68 may be integrally formed with main body 16. Insert 68 may define outlet liquid passage 60 therethrough and may also include a hole in which straw 66 is received and optionally retained therein by way of press-fitting, threading, gluing or bonding for example. In some embodiments, outlet cap 28 may be manufactured by (e.g., injection) molding. Insert 68 and straw 66 may be manufactured by a suitable extrusion or molding process. Outlet cap 28, insert 68 and straw 66 may be made from suitable polymeric material(s).

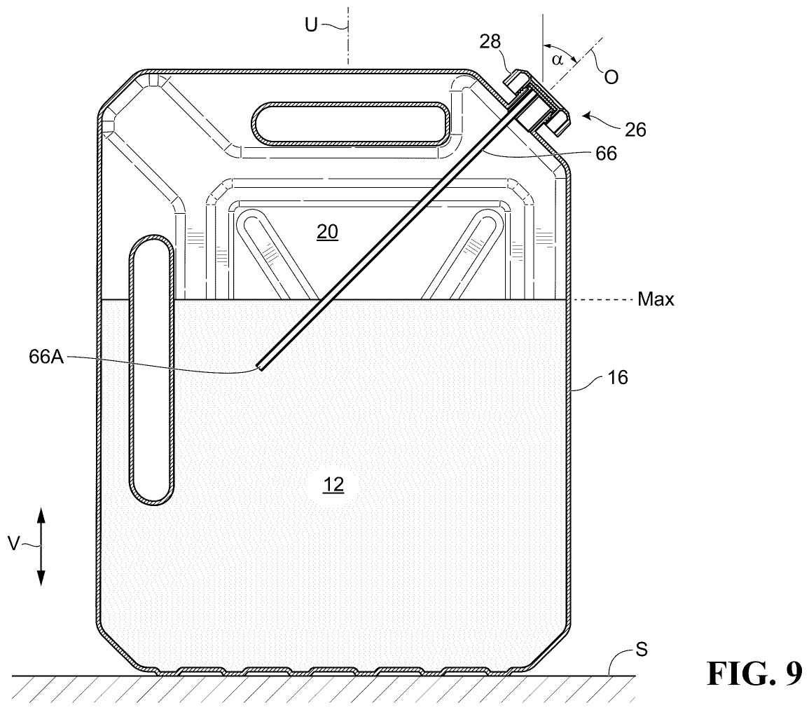

FIG. 9 is a cross-sectional view of container 10 in the upright orientation taken in a vertical plane that is normal to the viewing direction of FIG. 9. Outlet axis O may be non-parallel to upright axis U. Upright axis U and outlet axis O may be coplanar. In some embodiments, outlet axis O may be oriented at angle α between 25° and 65° from upright axis U. In some embodiments, outlet axis O may be oriented at angle α between 35° and 55° from upright axis U. Such orientation of outlet axis O may facilitate venting and the manual tilting and pouring of liquid 12 out of vessel 20. The orientation of outlet axis O may also permit outlet cap 28 to be contained within a rectangular footprint of the whole container 10 to promote efficient storage, packaging and shipping of one or more containers 10.

FIG. 9 also shows liquid 12 contained in vessel 20 being up to the MAX level. The MAX level may correspond to the maximum liquid capacity of vessel 20 shown in FIG. 3 but may not necessarily occupy all of the available volume inside of vessel 20. In the upright orientation of container 10, straw 66 may extend sufficiently far into vessel 20 to extend through the MAX level. In other words, intake end 66A of straw 66 may disposed below the MAX level and potentially extend into liquid 12. In some embodiments, a length of straw 66 may be selected so that intake end 66A of straw 66 is located at about a longitudinal (e.g., vertical) mid point of container 10 when container 10 is in the upright orientation. In some embodiments, a length of straw 66 may be selected so that intake end 66A of straw 66 is located within ±20% of an overall longitudinal dimension of container 10 from a longitudinal mid point of container 10. In some embodiments, a length of straw 66 may be selected so that intake end 66A of straw 66 is located within ±10% of the overall longitudinal dimension of container 10 from a longitudinal mid point of container 10. In some embodiments, a length of straw 66 may be selected so that intake end 66A of straw 66 is located within ±5% of an overall longitudinal dimension of container 10 from the longitudinal mid point of container 10.

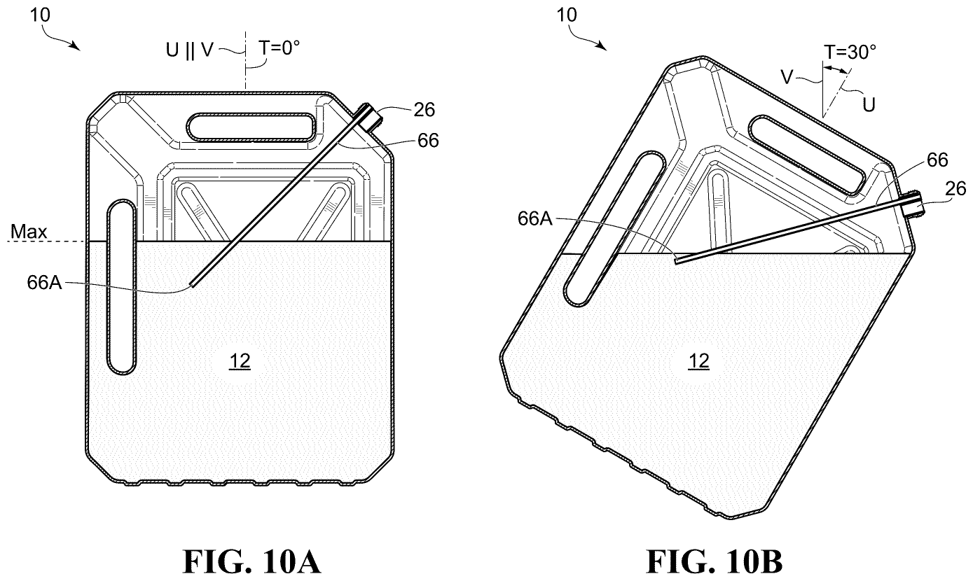

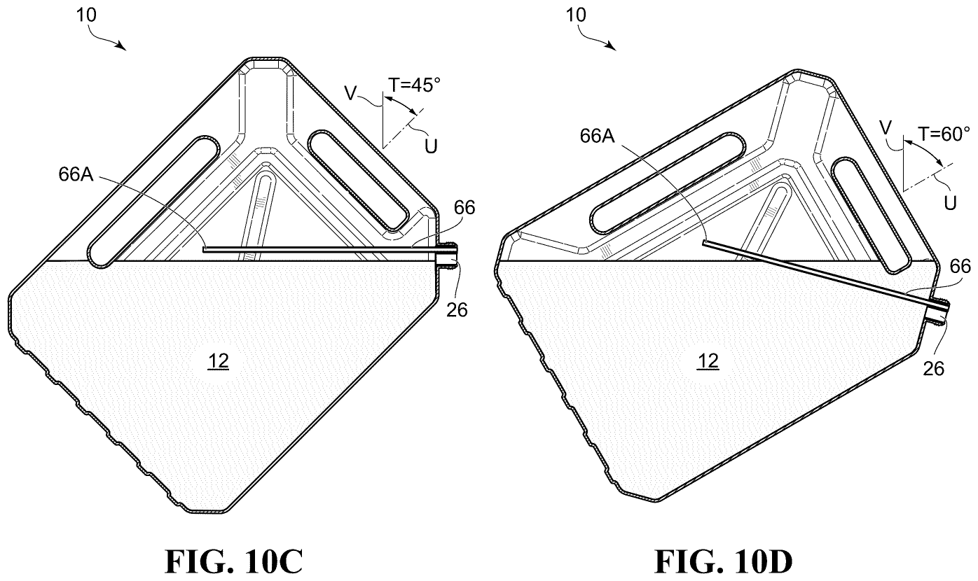

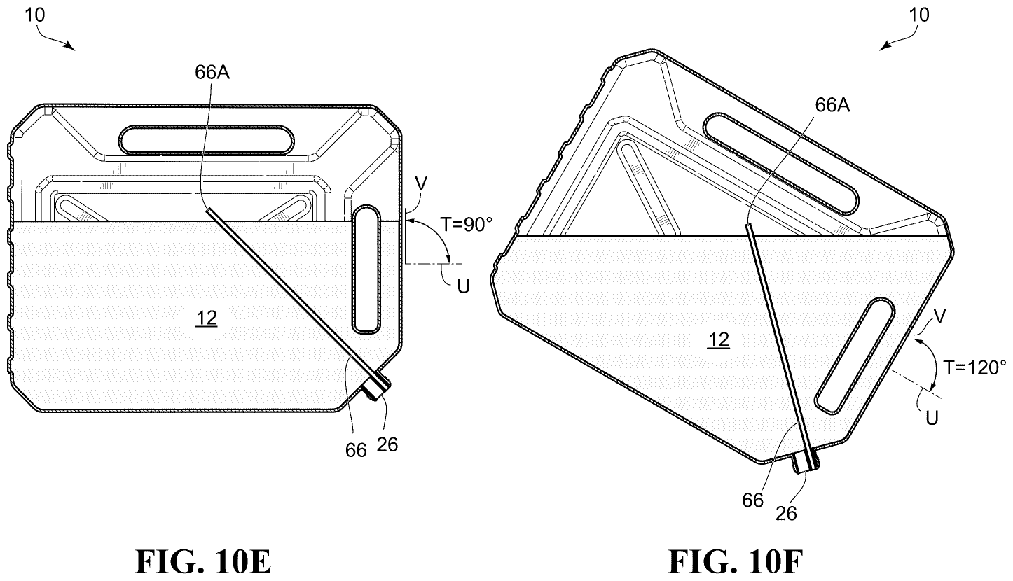

FIGS. 10A-10F are cross-sectional views of container 10 in the upright orientation taken in a vertical plane that is normal to the viewing direction of FIG. 10, and respectively show a plurality of instances of container 10 at different tilt orientations to show liquid 12 contained therein in relation to venting straw 66. The orientation, positioning and length of straw 66 may facilitate unobstructed venting of vessel 20 while pouring liquid 12 out of vessel 20. The venting of vessel 20 via straw 66 may facilitate a more stable flow out of outlet liquid passage 60 during pouring. The different tilt orientations are represented by tilt angle T between upright axis U and the vertical direction V. At a tilt angle T of 0° as shown in FIG. 10A, upright axis U is parallel to vertical direction V and container 10 is illustrated as containing liquid 12 to the MAX level and intake end 66A of straw 66 being submerged. At a tilt angle T of 30° as shown in FIG. 10B, intake end 66A of straw 66 is still submerged but vented outlet 26 is not submerged with liquid 12. At a tilt angle T of 45° as shown in FIG. 10C, intake end 66A of straw 66 is above liquid 12 and vented outlet 26 is partially submerged with liquid 12 indicating that venting and pouring would occur. In some embodiments, container 10 may be sized and vented outlet 26 may be configured so that pouring would begin at a tilt angle of between 40° and 50° (e.g., around the tilt angle T of 45°) when container 10 contains liquid 12 to the MAX level. At a tilt angle T of 60° as shown in FIG. 10D, intake end 66A of straw 66 is above liquid 12 and vented outlet 26 is submerged with liquid 12 indicating that venting and pouring would occur. At a tilt angle T of 90° as shown in FIG. 10E, intake end 66A of straw 66 is above liquid 12 and vented outlet 26 is submerged with liquid 12 indicating that venting and pouring would occur. At a tilt angle T of 120° as shown in FIG. 10F, intake end 66A of straw 66 is above liquid 12 and vented outlet 26 is submerged with liquid 12 indicating that venting and pouring would occur.

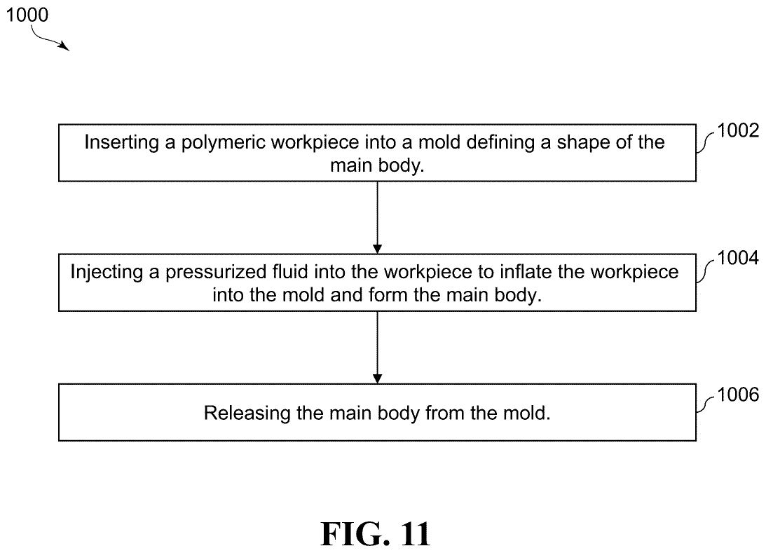

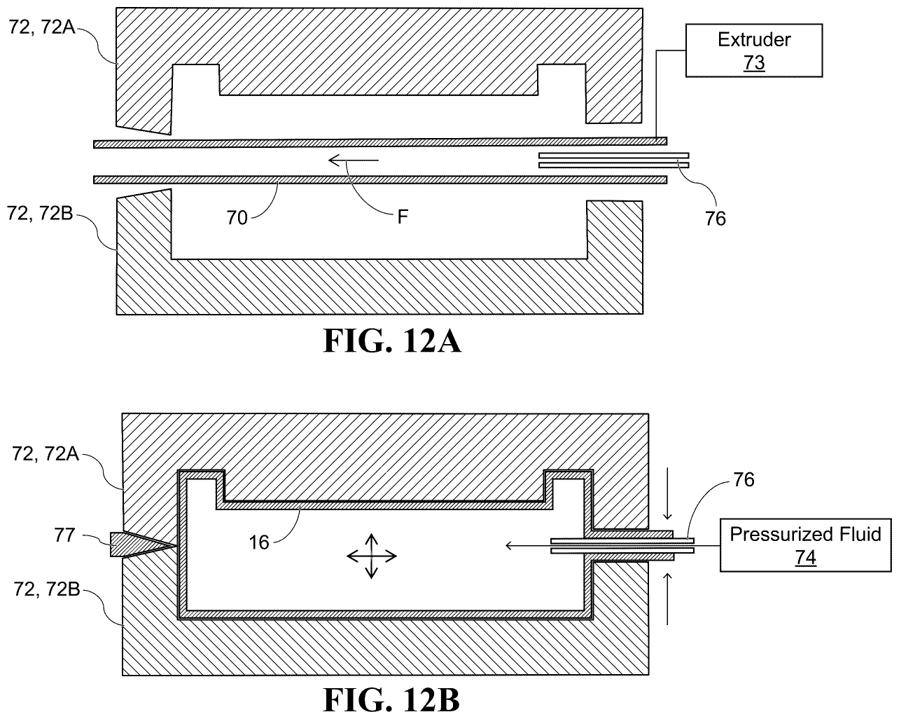

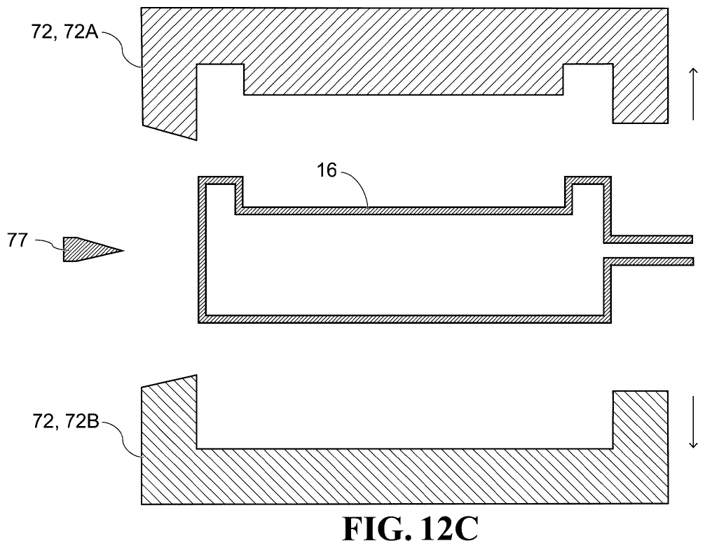

FIG. 11 is a flow diagram of an exemplary method 1000 for (e.g., extrusion or injection) blow-molding integrally-formed main body 16 of container 10 or other container for collecting and containing liquid 12 drained from vehicle 14. In some embodiments, main body 16 may not necessarily all be integrally formed and may not necessarily be manufactured using method 1000. In various embodiments, method 1000 may include:
inserting polymeric workpiece 70 (shown in FIG. 12A) into mold 72 (shown in FIG. 12A) defining a shape of main body 16 (block 1002);
injecting pressurized fluid 74 into workpiece 70 to inflate workpiece 70 into mold 72 and form main body 16 (block 1006); and
releasing (optionally unfinished) main body 16 from mold 72.

Various aspects of method 1000 are explained below in conjunction with the subsequent figures.

FIGS. 12A-12C schematically illustrate steps of an extrusion blow molding operation for forming main body 16 of container 10. FIG. 12A shows mold 72 including first mold half 72A and second mold half 72B that are separated to allow for workpiece 70 to be inserted in the mold cavity defined between mold halves 72A, 72B. Workpiece 70 may be a hollow piece of polymeric material that has been softened by heating. When extrusion blow molding is used, workpiece 70 may be a tubular parison that is formed using extruder 73 and that is fed into mold 72 in the direction of arrow F. Workpiece 70 may be made from a suitable thermoplastic polymer that is suitable for exposure to the types of liquid 12 expected to be collected with container 10. In some embodiments, workpiece 70 may be made from high density poly ethylene. Nozzle 76 may be inserted into workpiece 70 to deliver pressurized fluid 74 (e.g., air) inside of workpiece 70.

The mold cavity may be configured to define an outer shape of main body 16. In some embodiments, mold 72 may be configured to define substantially all features of main body 16 and may optionally include additional elements (e.g., inserts). Alternatively, some features of main body 16 may be formed by way of one or more subsequent (e.g., finishing) operations performed after blow molding.

FIG. 12B shows mold halves 72A, 72B having been brought together in order to close mold 72 with workpiece 70 disposed inside of the mold cavity. With mold 72 closed, pressurized fluid 74 such as pressurized may be injected (i.e., blown) into workpiece 70 via nozzle 76 to cause workpiece 70 to inflate into the shape of mold 72 and form main body 16. Excess material 77 may be trimmed (i.e., pinched off) during the closing of mold 72 or may be removed from main body 16 by way of a subsequent finishing (e.g., trimming) operation.

FIG. 12C shows mold halves 72A, 72B having been separated to open mold 72 after the inflation of workpiece 70 and after the depressurization and cooling of workpiece 70. With mold 72 open, molded main body 16 may be removed from mold 72 and may be subjected to one or more finishing operations if necessary. Excess material 77 may be recycled or discarded.

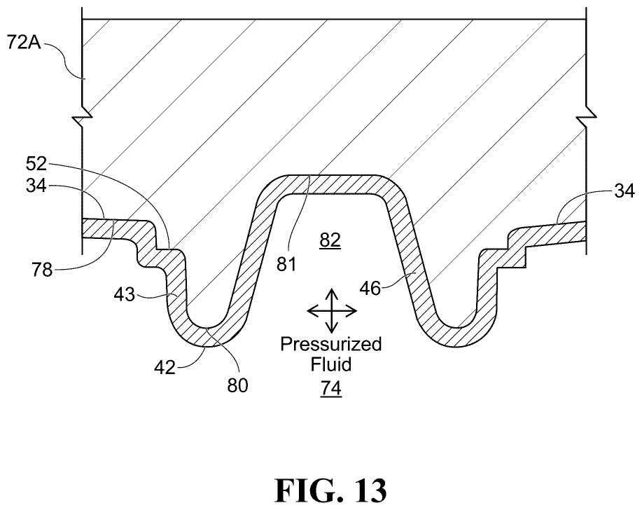

FIG. 13 is a schematic cross-sectional view of a portion of mold half 72A of mold 72 for blow molding part of main body 16 in a region of vented inlet 22. Mold half 72A may include various geometric features such as cavities, bosses, pins, grooves, etc. that are configured to form various parts of main body 16. For example, mold half 72A may include first mold surface 78 for molding pan 18 of main body 16. Mold half 72A may include second mold surface 80 for molding wall 42 of vented inlet 22 intended to have one or more inlet liquid passages extending therethrough to permit liquid 12 collected by pan 18 to be received into vessel 20 during use. Mold half 72A may include third mold surface 81 defining cavity 82 extending from second mold surface 80 for molding protrusion 46 of vented inlet 22 protruding from wall 42 of vented inlet 22. Cavity 82 may have a frustoconical or other shape. Second mold surface 80 for molding wall 42 of vented inlet 22 may be offset from first mold surface 78 for molding pan 18.

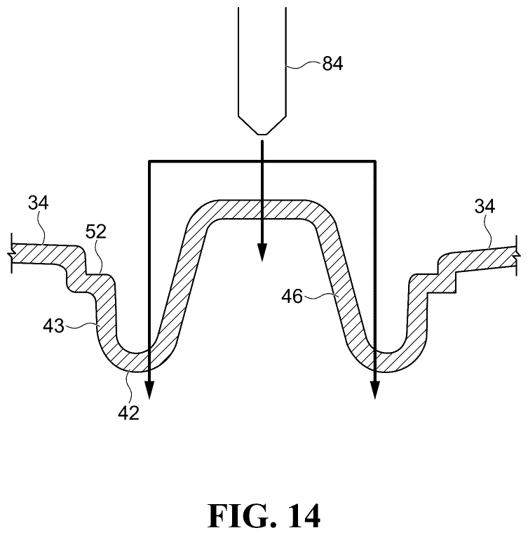

FIG. 14 is a schematic cross-sectional view of a portion of main body 16 in conjunction with tool 84 (e.g., drill bit) for forming holes in the region of vented inlet 22. After blow molding, main body 16 may optionally be subjected to one or more finishing (e.g., material removal) operations to form features of main body 16. For example, inlet liquid openings 40 may be formed after releasing main body 16 from mold 72. Tool 84 may be used to form (e.g., drill) inlet liquid openings 40 into wall 42 of vented inlet 22. Tool 84 may be used to form (e.g., drill) inlet vent opening 44 into protrusion 46 of vented inlet 22. Inlet vent opening 44 may be formed atop (e.g., frustoconical) protrusion 46 of vented inlet 22.

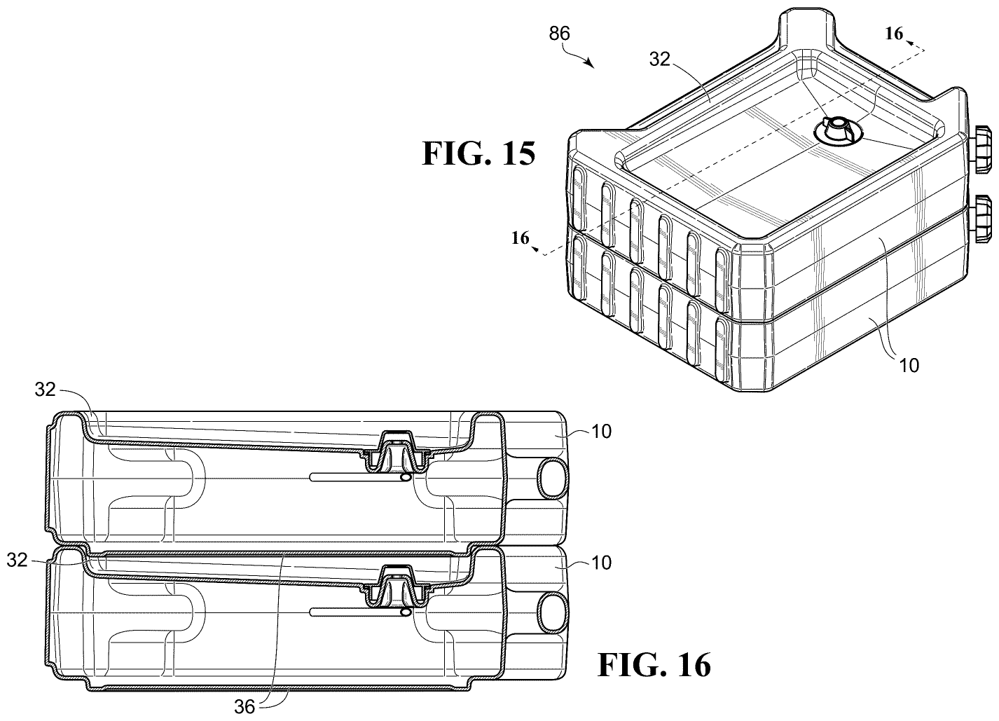

FIG. 15 is a perspective view of stack 86 of two exemplary containers 10 stacked together. FIG. 16 is a cross-sectional view of stack 86 of containers 10 taken along line 16-16 in FIG. 15. A plurality of containers 10 may be stacked together during warehousing, shipping and/or retailing operations (e.g., in a retail display). The shape of container 10 may be configured to facilitate stacking. For example, container 10 may be configured to permit nesting of containers 10 that are stacked together. For example, when stacked together, bottom pad 36 of an upper container 10 may protrude downwardly from a remainder of main body 16 and be sized to fit within mouth 32 of pan 18 of a lower container 10. Accordingly, when stacked together, bottom pad 36 may be received into mouth 32. When stacked together, a bottom surface of upper container 10 that is adjacent to (e.g., surrounding) bottom pad 36 may rest on a top surface of lower container 10 that is adjacent to (e.g., surrounding) mouth 32 of pan 18. In some embodiments, bottom pad 36 of upper container 10 and mouth 32 of lower container 10 may laterally interlock upper container 10 and lower container 10 together to prevent excessive relative lateral sliding movement between upper container 10 and lower container 10. In some embodiments, bottom pad 36 and mouth 32 may having conforming shapes and may be sized to provide a relatively small (e.g., 1 mm) clearance therebetween.

As can be seen therefore, the examples described above and illustrated are intended to be exemplary only. The scope is indicated by the appended claims.

1. A container for collecting and containing a liquid drained from a vehicle, the container comprising:
a pan for collecting the liquid drained from the vehicle;
a vessel for containing the liquid collected with the pan, the vessel including:
a vented inlet operable to permit the liquid collected by the pan to be received into the vessel, the vented inlet including an inlet liquid passage and an inlet vent; and
a vented outlet operable to permit the liquid contained in the vessel to be poured out of the vessel, the vented outlet including an outlet liquid passage and an outlet vent;
an inlet cap operable to selectively occlude the vented inlet to prevent liquid flow out of the vessel via the vented inlet; and
an outlet cap operable to selectively occlude the vented outlet to prevent liquid flow out of the vessel via the vented outlet.

2. The container as defined in claim 1, wherein the vessel is devoid of a manually actuatable vent outside of the vented outlet and outside of the vented inlet.

3. The container as defined in claim 1, wherein the vessel is devoid of an additional vent outside of the vented outlet and outside of the vented inlet.

4. The container as defined in claim 1, wherein the container is devoid of an additional cap other than the inlet cap and the outlet cap.

5. The container as defined in claim 1, wherein, when the container is in a liquid-collecting orientation:
the pan includes a pan surface downwardly sloped toward the vented inlet;
the inlet liquid passage includes an inlet liquid opening defined in a wall of the vessel; and
the inlet vent includes an inlet vent opening that is above the inlet liquid opening.

6. The container as defined in claim 5, wherein the inlet liquid opening is below a portion of the pan surface adjacent the vented inlet.

7. The container as defined in claim 6, wherein the vent opening is above the portion of the pan surface adjacent the vented inlet.

8. The container as defined in claim 5, wherein the vent opening is above a portion of the pan surface adjacent the vented inlet.

9. The container as defined in claim 5, wherein the vent opening is located centrally of the vented inlet.

10. The container as defined in claim 5, wherein:
the inlet liquid opening is one of a plurality of inlet liquid openings of the vented inlet; and
the vent opening is located centrally of the plurality of inlet liquid openings.

11. The container as defined in claim 5, wherein the vent opening is disposed atop a protrusion extending upwardly from the wall.

12. The container as defined in claim 11, wherein the protrusion has a frustoconical shape.

13. The container as defined in claim 11, wherein the protrusion is integrally formed with the wall of the container in which the inlet liquid opening is defined.

14. The container as defined in claim 11, wherein:
the protrusion extends above at least part of the pan surface; and
the inlet cap is shaped to accommodate the protrusion therein.

15. The container as defined in claim 1, wherein:
the outlet liquid passage extends along an outlet axis;
the container has an upright axis that is:
horizontal when the container is disposed on a horizontal surface in a liquid-collecting orientation; and
vertical when the container is disposed on the horizontal surface in an upright orientation;
the vented outlet is in an upper portion of the container when the container is in the upright orientation; and
the outlet axis is between 25° and 65° from the upright axis.

16. The container as defined in claim 15, wherein the upright axis and the outlet axis are coplanar.

17. The container as defined in claim 15 wherein:
the outlet vent is defined by a straw that extends into the vessel; and
the straw is longer than the liquid outlet passage.

18. The container as defined in claim 17, wherein an entirety of the straw is parallel to the outlet axis.

19. The container as defined in claim 1, wherein:
the container includes a bottom pad for engaging a support surface when the container is in a liquid-collecting orientation; and
the bottom pad is sized to fit in a mouth of a pan of another identical container and permit the bottom pad to be received in the mouth of the other container when the container and the other container are stacked.

20. A container for collecting and containing a liquid drained from a vehicle, the container comprising:
a pan for collecting the liquid drained from the vehicle when the container is in a liquid-collecting orientation; and
a vessel for containing the liquid collected with the pan, the vessel including:
a vented inlet operable to permit the liquid collected by the pan to be received into the vessel, the vented inlet including:
a trough defining a liquid opening into the vessel; and
a protrusion surrounded by the trough and defining a vent opening for venting the vessel, the protrusion extending upwardly relative to the trough so that the vent opening is disposed higher than the liquid opening when the container is in the liquid-collecting orientation, the protrusion being integrally formed with the trough; and
an outlet operable to permit the liquid contained in the vessel to be removed from the vessel.

21.-33. (canceled)

34. A container for collecting and containing a liquid drained from a vehicle, the container comprising:
a pan for collecting the liquid drained from the vehicle when the container is in a liquid-collecting orientation;
a vessel for containing the liquid collected with the pan, the vessel including:
a vented inlet operable to permit the liquid collected by the pan to be received into the vessel, the vented inlet including:
a perforated trough defining a liquid opening into the vessel; and
a protrusion surrounded by the trough and defining a vent opening for venting the vessel, the protrusion extending upwardly relative to the trough so that the vent opening is disposed higher than at least part of the pan when the container is in the liquid-collecting orientation; and
an inlet cap operable to selectively occlude the vented inlet to prevent liquid flow out of the vessel via the vented inlet, the inlet cap being shaped to accommodate the protrusion therein.

35.-40. (canceled)
